(19) United States
(12) Patent Application Publication
(10) Pub. No.: US 2016/0160004 A1
(43) Pub. Date: Jun. 9, 2016

(54) Polyester Forming Rollstocks, Laminates, and Methods of Making the Same

(71) Applicant: CLEAR LAM PACKAGING, INC., Elk Grove Village, IL (US)

(72) Inventors: Jeanne M. Skaggs, Arlington Heights, IL (US); Roman Forowycz, Lake Forest, IL (US); Pat Montefusco, Genoa, IL (US); James B. Hirst, Elgin, IL (US)

(21) Appl. No.: 14/929,200

(22) Filed: Oct. 30, 2015

Related U.S. Application Data
(60) Provisional application No. 62/072,859, filed on Oct. 30, 2014.

(51) Int. Cl. C08K 5/101; B32B 27/36; C08J 3/22; C08K 3/34; C08K 3/04

(52) U.S. Cl. CPC C08K 5/101; C08K 3/34; C08K 3/04; C08J 3/22; B32B 27/36; C08J 2367/02; B32B 2250/40; B32B 2367/00

(57) ABSTRACT

A thermoformable polyester roll stock can include polyester, talc, and an ethylene acrylate. The talc can be provided in an amount of about 10 wt % to about 20 wt % based on the weight of the film and the ethylene acrylate can be provided in an amount up to about 6 wt % based on the weight of the film. Laminates can be formed using the such polyester roll stocks.

### CROSS-REFERENCE TO RELATED APPLICATION

This application claims the priority benefit under 35 U.S.C. §119(e) of U.S. Provisional Patent Application No. 63/072,859 filed Oct. 30, 2014, the disclosure of which is incorporated herein in its entirety.

### BACKGROUND

1. Field of the Disclosure

The disclosure relates to thermoformable polyester roll stocks and laminates and methods of making the laminates.

2. Brief Description of Related Technology

Thermoformable roll stocks and laminates have been used in a variety of applications to provide convenient and durable packaging for food products and other consumer goods. In applications related to food packaging, in particular, it can be desirable to package the products in containers that are resistant to both high and low temperatures. Low temperature resistant packaging can be desirable where the products are desired to be stored in a freezer, for example. High temperature resistance can be desirable when sterilization is required or hot fill techniques are utilized. Many food and beverage packages are produced using plastic roll stocks such as polypropylene roll stocks, polyethylene roll stocks, polystyrene roll stocks and polyester roll stocks. Polyester-based roll stocks, however, can be susceptible to thermal distortion during the hot fill process, causing defects in the packaging, such as malformation of the container, flange waviness that can impede sealing, indented side walls, shrunken bottom and/or walls, reduction of the container volume, and other defects imparting a visual appearance that the cup has been damage or tampered with. Such defects can result in structural problems with the packaging, such as leakage, as well as being non-aesthetically pleasing to consumers. Consumers may view such defects as an indication that the package or its contents have been contaminated or tampered with. It can also be difficult to make aesthetically pleasing and decorative containers that are temperature resistant using conventional forming roll stocks.

### SUMMARY OF THE DISCLOSURE

In many packaging applications, consumers desire decorative and aesthetically pleasing containers. While containers made from thermoformable roll stocks and laminates can advantageously provide lightweight, cost-effective, and/or more eco-friendly packaging as compared to rigid materials such as metal and glass, plastic-looking containers can be displeasing to consumers. Thus, there remains a need for thermoformable materials that can provide lightweight and cost-effective packaging that is more aesthetically pleasing to consumers and/or resembles more rigid, non-plastic containers. The forming materials disclosed herein can advantageously provide for temperature resistant durable containers. The forming roll stocks disclosed herein can also advantageously provide for containers having improved aesthetic properties, such as resembling more expensive metal containers.

### BRIEF DESCRIPTION OF THE DRAWINGS

FIG. 1A is a photograph of a top view of cups thermoformed from forming roll stocks in accordance with embodiments of the disclosure;

FIG. 1B is a photograph of a bottom view of the cups of FIG. 1A;

FIG. 2A is a photograph showing a perspective view of thermoform cups formed from a laminate in accordance with embodiments of the disclosure;

FIG. 2B is a photograph showing a top (inside) view of the cups of FIG. 2A;

FIG. 2C is a photograph showing a bottom (outside) view of the cups of FIG. 2A;

FIG. 3 is a schematic illustration of a conventional extrusion process using a single screw extruder, in which a colorant masterbatch is added to the extrusion melt after it is processed through the crystallizers and dryers of the extruder; and

FIG. 4 is a schematic illustration of an extrusion process in accordance with an embodiment of the disclosure.

### DETAILED DESCRIPTION

Disclosed herein are thermoformable polyester-based roll stocks and laminates. The roll stocks and laminates in accordance with the disclosure can have hot and/or cold temperature resistance. The roll stocks and laminates in accordance with the disclosure can also be resistant to heat distortion, which can occur, for example, when using hot fill techniques. In accordance with embodiments of the disclosure, the roll stocks and laminates can have improved aesthetic properties, for example, providing containers having improved appearance, such as resembling metal containers. It has been advantageously discovered that laminates of the disclosure can include a metallization layers to provide for such improved appearance that is resistant to degradation during the thermoforming process. In contrast, conventional laminates having conventional materials metallized are susceptible to abrasion or separation of the metallization layer during the thermoforming process.

In accordance with embodiments of the disclosure, the roll stocks and laminates can include talc in at least one of the layers of the roll stock or one of the laminate layers. In various embodiments, the roll stocks and laminates can include about 10 wt % to about 20 wt % of talc, based on the total weight of the roll stock (if single layer roll stock), roll stock layer in which the talc is present (if multilayer roll stock), or laminate layer. While talc has been identified as a processing aid, which can improve the heat distortion properties of polyesters, plastic compositions utilizing talc in sufficient amounts to allow for the improved properties have generally been used in other plastic processing methods, such as injection molding and cast films. For example, Yamada & and Thumsorn found that talc improved the heat distortion temperatures of the blends of RPET and E-GMA for use as an injection molding plastic. Yamada & Thumsorn described the incorporation of polyethylene-glycidyl-methacrylate (E-GMA) and talc into recycled polyethylene terephthalate (RPET) to improve impact resistance, stiffness, and heat distortion resistance of the material for use in injection molding. Yamada & Thumsorn, Effectiveness of Talc Filler on Thermal Resistance of Recycled PET Blends, 3 Advances in Mat'ls Physics and Chem. 327-331 (2013). As described in U.S. Pat. No. 7,655,291, talc has also been used in connection with polyester cast films to reduce transparency and reduce gloss. The '291 patent notes that talc has only moderate adhesion to polyesters and utilized a cast film process with subsequent biaxial stretching to produce the talc containing polyester film.

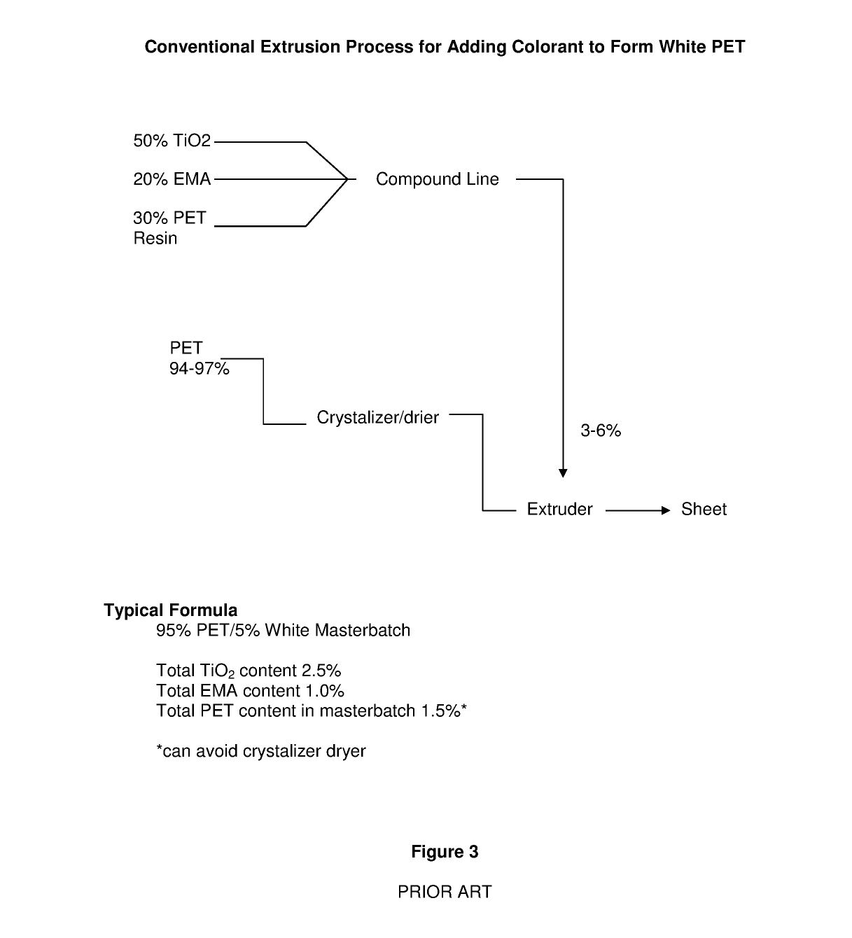

However, when compounding talc with the polyester materials in an extrusion process, it was found that the loss of viscosity during the melting resulted in the heavier talc material segregating and coagulating rather than uniformly dispersing in the polyester carrier. Furthermore, the talc was found to segregate from the polyester and flow to the outside edges of the extruded sheet. Agglomeration of the talc can results in raised features in the extruded sheet. Other defects resulting from poor talc dispersion include warpage of the sheet, non-uniform shrinkage, fisheyes, dimples, pinhole defects, and bumps or raised features (resulting from agglomerated talc). The roll stocks of the disclosure can allow for the incorporation of sufficiently high talc loading, which can provide improved heat distortion properties, such as at least 10 wt % talc, without concomitant problems of defects in the material that can results from agglomeration and poor dispersion of the talc in the polyester. Without intending to be bound by theory, it is believed that the addition of an ethylene acrylate in the extrusion melt can result in substantially uniformly dispersion the talc throughout the polyester and reduce talc agglomeration. While ethylene acrylates have been used as an additive when incorporating particulate-based colorant into extruded polyester roll stocks, it is generally understood in the art that ethylene acrylates are temperature sensitive and cannot be successfully added to the extrusion melt that is processed through the crystallizers and dryers of the extruder when used in typical amounts. Instead, as shown in FIG. 3, conventionally, the ethylene acrylate and colorant is added to the polyester roll stock through the use of a masterbatch that bypasses the crystallizers and dryers of the extruder. Such masterbatches typically include a relatively small amount, such as 10 wt % or less, of carrier resin, with higher contents of the colorant and the ethylene acrylate. A crystallizer dryer typically heats the polyester to temperatures of about 145° C. or greater to remove moisture from the polyester, but not melt the polyester. However, at such temperatures the ethylene acrylate will melt. With the amount of ethylene acrylate used in conventional masterbatches for dispersing particular colorant, the melting of the ethylene acrylate in the crystallizer dryer prevents the mixture from being processed through the extruder. As the ethylene acrylate melts it separates from the polyester and then agglomerates upon cooling after the crystallizing drying process, which results in globules that cannot be processed through the feeding system of the extruder. In conventional colorant masterbatches, amounts of 20% ethylene acrylate or more are used to disperse the colorant. Given the relatively low amount of carrier resin (i.e., polyester) present in the masterbatch, there is no need to process the masterbatch through a crystallizer dryer. Thus, the problem of melting and agglomeration of the ethylene acrylate when processed at temperatures of the crystallizer dryer can be avoided.

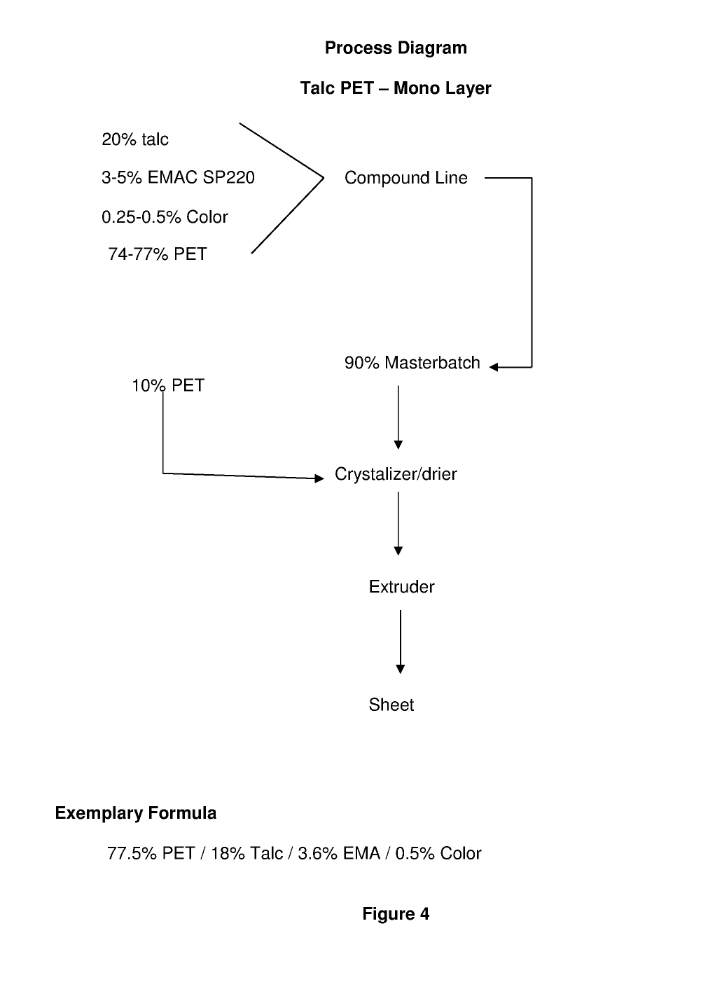

It has surprisingly found that significantly lower than conventional amounts of ethylene acrylate can be used in the formulations of the disclosure, while providing the benefit of improved dispersion of the talc throughout the polyester. In the amounts used in the formulations of the disclosure it was surprisingly discovered that the ethylene acrylate can be successfully processed through the crystallizer dryer without excessive separation. A suitable viscosity can be maintained for later processing through the screw. While some agglomeration may occur, it is manageable and was surprisingly found to not to adversely affect the downstream processing or resulting extruded roll stock. Referring to FIG. 4, a process in accordance with the disclosure can include preparing a masterbatch comprising the talc, ethylene acrylate, and polyester in a compounding line. The process can further include mixing the masterbatch with additional polyesters and then processing the mixture through the crystallizers and dryer. In contrast to conventional processes in which ethylene acrylate is included in a masterbatch having a relatively low content of polyester, the process in accordance with the disclosure includes a relatively high amount of polyester in the masterbatch, for example about 70 wt % to about 80 wt % based on the total weight of the masterbatch. In view of this higher content of polyester, it is beneficial to process the masterbatch through the crystallizers and dryers to allow for sufficient crystalline formulation and moisture reduction for polyester roll stock formation. It has been surprisingly found that ethylene acrylates can be processed through the crystallizer and dryer of the extruder when combined with the talc, without thermal degradation of the ethylene acrylate.

The process of the disclosure can include mixing the polyester, talc, and ethylene acrylate, crystallizing and drying the mixture, extruding the mixture through a single screw. As noted above, the talc and ethylene acrylate can be compounded into a masterbatch in a compounding line prior to the extrusion process. The masterbatch can then be mixed with additional polyester and then processed through the extrusion process, including crystalizing and drying. In various embodiments, the process can be used to produce a roll stock of roll stock.

In accordance with an embodiment, the masterbatch can be added to form the extrusion mixture in an amount of about 80 wt % to about 99 wt % , with the remaining amount being polyester, for example about 1 wt % to about 20 wt %. For example, the extrusion mixture can include about 80 wt % to about 95 wt % masterbatch and about 5 wt % to about 20 wt % polyester. In other embodiments, a polyester, talc, and ethylene acrylate can be combined directly or 100% masterbatch can be used. The final mixture for processing through the crystallizer can include about 10 wt % to about 20 wt % talc based on the total weight of the mixture. The final mixture for processing through the crystallizer can include up to about 6 wt % of the ethylene acrylate. At least some amount of ethylene acrylate is present in the mixture.

In an embodiment, the masterbatch can include about 10 wt % to about 20 wt % of talc. Other suitable amounts of talc in include about 10, 11, 12, 13, 14, 15, 16, 17, 18, 19, and 20 wt %. The masterbatch can include about 0.1 wt % to about 6 wt % ethylene acrylate. Other suitable amounts include about 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, and 6 wt %. The masterbatch can include other additives, such as colorants. The remaining amount is polyester. For example, the masterbatch can include about 70 wt % to about 89 wt % polyester.

In any of the embodiments, the ethylene acrylate can be, for example, ethyl methyl acrylate (EMA), ethylene ethyl acrylate (EEA), and ethylene butyl acrylate (EBA), and copolymers and combinations thereof. In any of the embodiments, the ethylene acrylate can be included in an amount of up to about 6 wt % based on the total weight of the roll stock, roll stock layer, or laminate layer in which it is included. The ethylene acrylate is present in at least some amount. For example, the ethylene acrylate can be present in an amount of about 0.1 wt % to about 6 wt %, about 0.5 wt % to about 5 wt %, about 1 wt % to about 6 wt %, and other ranges in between.

In any of the embodiments, the talc can be provided in an amount of about 10 wt % to about 20 wt % based on the total weight of the roll stock, roll stock layer, or laminate layer in which the talc is include. Other suitable ranges include about 12 wt % to about 18 wt %, about 10 wt % to about 15 wt %, about 15 wt % to about 20 wt %, or about 14 wt % to about 18 wt %. Other suitable amounts include 10, 11, 12, 13, 14, 15, 16, 17, 18, 19 and 20 wt %. At amounts below 10 wt %, it was observed that the talc did not provide a benefit of improved heat distortion properties to a thermoformed sheet. At amounts above 20 wt %, it is difficult to incorporate the talc uniformly even with the aid of the ethylene acrylate and there was no observed improvement to heat resistance at higher levels. Other minerals and synthetic fillers known to be capable of imparting heat distortion resistance are also contemplated herein for addition in suitable amounts, such as for example, about 10 wt % to about 20 wt %. These can be added in addition to or as an alternative to the talc.

The talc can have a particle size of 2 microns or less. Suitable ranges of particle sizes include about 1 microns to about 2 microns.

In any of the embodiments, the polyester can be selected from the group consisting of polyethylene terephthalate (PET). Virgin and recycled PET can be used. For example, PET, PET-G, R-PET, and post consumer recycled PET can be used, as well as combinations and blends thereof. The polyester can have a degree of orientation of 10% or less. Some degree of orientation is imparted due to the machine direction of the extruder. The polyester can have, for example, a degree of orientation of about 2% to about 10%, about 3% to about 7%, or about 4% to about 6%. In various embodiments, the polyester can be completely un-oriented.

The roll stock can be provided as a single-layer extruded structure or a co-extruded multi-layer structure. In embodiments where the roll stock is a single-layer extrusion, the roll stock includes the talc, polyester, and ethylene acrylate. Additional known additives, including but not limited to, impact modifiers, colorants, chain extenders, and other processing aids can be added.

Exemplary multi-layer structures include AB structures, ABA structures, and ABC structures. In accordance with an embodiment, the A layer can include polyester and the B layer can include polyester, talc, and ethylene acrylate. In accordance with another embodiment, the A layer can include polyester and colorant, and the B layer can include polyester, talc, and ethylene acrylate. In either embodiment, the A layer can further include a color. In embodiments including the C layer, either of the A and B layer combinations described above can be used, and the C layer can include polyester with or without a colorant and other additives such as impact modifies and processing aids. The colorant can be different than the colorant of the A layer, where the A layer includes a colorant. In any of the foregoing embodiments, any or all of the layers can further include common additives, including impact modifiers, additional colorants, chain extenders, and other processing aids.

In embodiments in which the multi-layer structure has an AB structure, the layers can be provided in a thickness ratio of about 5:95 to about 50:50, about 10:90 to about 25:75, about 10:90 to about 20:80, about 15:85 to about 25:75, and other suitable ranges in between.

In embodiments in which the multi-layer structure has an ABA structure or an ABC structure, the layers can be provided with A layers (or A and C layers in the ABC structure) having the same or different thickness. For example, structure can have a layer thickness ratio of about 5:90:5 to about 20:60:20, about 10:80:10 to about 20:60:20, about 15:70:15 to about 10:80:10, about 10:70:20 to about 15:65:20, and other suitable ranges in between.

In accordance with an embodiment of the disclosure, the laminate can be multi-layer laminate structure. Any of the roll stock materials, including single layer and coextruded multi-layer structures, can be used in the laminate layers. The laminate can have any suitable number of layers. The layers can have any suitable composition depending on the properties of the resulting laminate. For example, barrier layers, decorative layers, resealable layers, print layers, heat sealable layers and other types of laminate layers can be included. Each laminate layer can have a single or multi-layer coextruded structure. In the laminates of the disclosure, at least one laminate layer includes layer having polyester, talc, and ethylene acrylate, as described above.

In accordance with an embodiment, the first laminate layer can be formed from any of the roll stocks described above including polyester, talc, and ethylene acrylate. In various embodiments, the first laminate layer can include a multi-layer structure having at least a first layer including the talc and ethylene acrylate with the polyester and a second layer having the polyester free of talc. Having a talc-free polyester layer can advantageously improve lamination to another structure, as compared to laminating with a talc-containing layer. The talc free polyester layer can include other additives, such as colorants or can be polyester free of any additives.

The second laminate layer can be, in an embodiment, polyethylene. Peelable or non-peelable polyethylene can be provided depending on the type of end use the laminate requires as is known in the art. A peelable polyethylene layer can provide the laminate with an external surface that allow for a peelable attachment of another material, such as for example, a lidding material in a cup The laminate layers are permanently adhered, even when a peelable polyethylene layer is provided.

In accordance with another embodiment, the second laminate layer can be formed from a coextruded multi-layer roll stock that includes a layer structure of polyethylene/tie layer/ethylene vinyl alcohol (EVOH)/tie layer/polyethylene. Such a second laminate layer can serve as a barrier layer. Other barrier layers can be used as well.

In accordance with another embodiment, the second laminate layer can be provided to allow for printing. For example, the second laminate layer can include polyester printed with an ink on one side or can include a colorant. For example, if a black colored polyester is desired, carbon black can be incorporated into the polyester. The colorant can be provided, for example, in an amount of about 1 to 10% by weight of the layer. The layer can include 90% to 100% polyester based on the weight of the polyester. Any suitable amounts of colorant can be used as is known in the art.

In accordance with yet another embodiment, the laminate can further include third laminate layer of polyester adhesively joined to the second laminate layer at the side of the second laminate layer printed with ink. This third laminate layer can advantageously protect the printed ink during use of the film. In another embodiment, the third laminate layer can be a vacuum metalized polyester layer, which can add a decorative finish to the laminate structure.

In accordance with an embodiment, the first laminate layer can include based on the total weight of the layer, about 70 wt % to 90 wt % of polyesters, up to about 20% talc, and up to about 5% ethylene acrylate. For example, in one embodiment, the layer can include about 78% PET, 17.4% talc, 4.35% EMA, and 0.32% colorant. Other additives including, but not limited to coloring agents can be included. The talc can have a particle size of less than 2 microns.

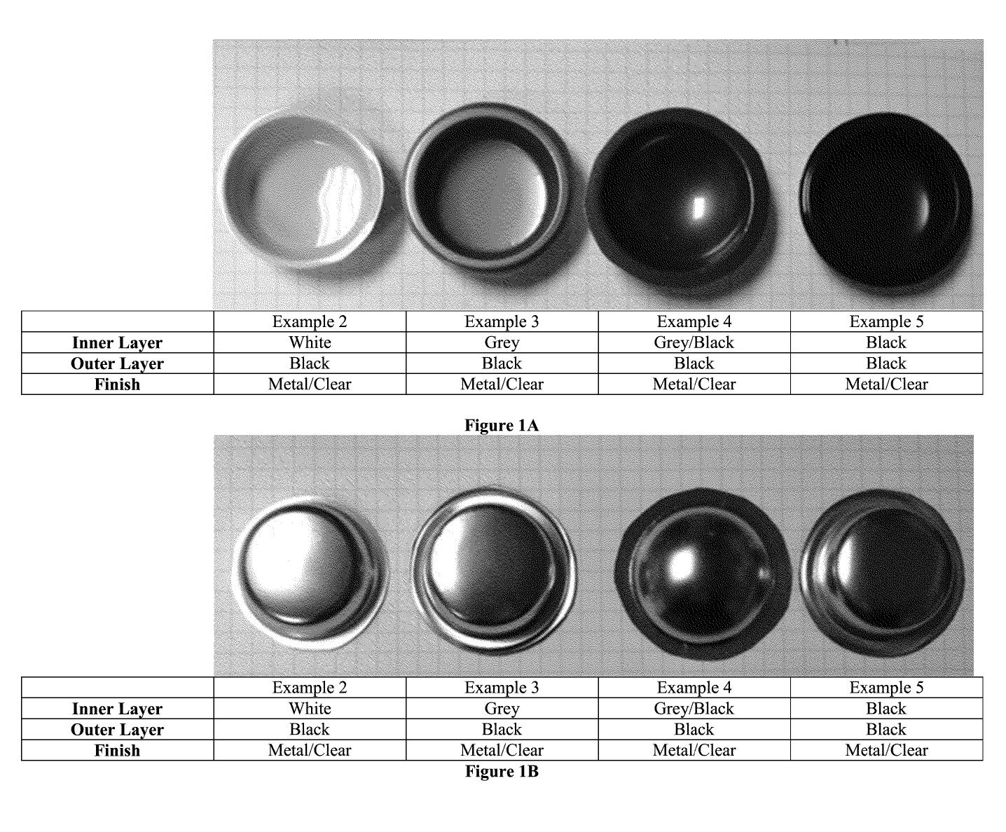

The first polyester layer can include a coloring agent to provide any desired color to the layer. The color of the first polyester layer can provide the coloring for one of the surfaces of a container formed from the laminate structure. For example, as shown in FIG. 1A, the color of the first polyester layer can be modified to modify the color of the inside of the cup formed from the laminate structure, as the inside surface of the cups corresponds to an exposed surface of the first polyester layer of the laminate structure. Any suitable coloring agent, such as a Color Masterbatch and known color concentrates, can be used. Any suitable amount of colorant needed to achieve the desired coloring can be used. For example, the colorant can be added in an amount of about 1 wt.% to about 10 wt %, or about 2 wt % to about 6 wt % based on the total weight of the layer. Other ranges of colorant are contemplated herein depending on the desired appearance of the finished thermoformed part.

A suitable commercially available PET material for use in the third polyester layer is PET grade P25 (DuPont Teijin). The at least one surface of the polyester roll stock can be treated for improved adhesion of the metallization layer to provide a metalized polyester. For example, the at least one surface can be Corona treated prior to coating with the metallization layer. The metallization layer can be formed of, for example, aluminum, silver, copper, gold, combinations and alloys thereof. The metallization layer can be applied by any techniques known in the art, including but not limited to, vacuum deposition of a metal onto one or both surfaces of the polyester sheet.

In any of the foregoing embodiments, the polyester in any laminate layer can be PET and any grades of PET known and described herein, including R-PET and PET from post consumer recyclables.

The laminate structure can have an overall thickness of about 5 mil to about 50 mils, about 10 mils to 40 mils, about 10 mils to 20 mils, about 15 mils to 30 mils, or about 5 mils to 10 mils. Other suitable thicknesses include, for example, about 5, 6, 7, 8, 9, 10, 11, 12, 13, 14, 15, 16, 17, 18, 19, 20, 21, 22, 23, 24, 25, 26, 27, 28, 29, 30, 32, 34, 36, 38, 40, 42, 44, 46, 48, and 50 mils.

The thicknesses and relative thicknesses of the polyester layers can depend on a variety of parameters, including the depth of draw during thermoforming and the desired coloring. For example, to achieve a uniform silver finish, the second polyester layer can be colored black and present in a thickness of at least about 3 mils such that the layer is not thinned during thermoforming to an extent to which it becomes transparent or substantially transparent. PET material is commercially available in thickness of about 0.5 mils and 0.75 mils, which can be suitable for use in the laminate layers depending on the depth of draw of the thermoformed part. For example, in thermoformed parts having an about 2 inch draw depth, the third and fourth layers can have a thickness of about 0.75 mils. Other thicknesses are contemplated herein depending on the features of the thermoformed part to be formed.

The laminate structure can be provided as sheets or as a roll stock. The laminate structure is capable of being thermoformed under conventional thermoforming process conditions. Advantageously, the laminates in accordance with the disclosure can be thermoformed without destruction, separation, or other damage to the metallization layer (when present), thereby allowing for metal-looking structures to be formed. Furthermore, the laminate structures can resist heat distortion when hot filled with a product, such as commonly used for jams and jelly.

In accordance with embodiments of the disclosure, the laminate structures can be made by first adhesively laminating a thermoformable polyester (described above as the third polyester layer) having at least one surface coated with a metallization layer to protective polyester layer (described above as the fourth polyester layer), for example, a substantially transparent polyester layer. Any suitable adhesives can be used. For example, the adhesive can be a polyurethane solvent based adhesive with high heat resistance.

The resulting structure can then be laminated to a non-metalized and optionally colored polyester layer (described above as the second polyester layer). Alternatively, the first and second layers can be coextruded and then laminated to the resulting structure (i.e., the third and fourth layers that have been adhesively bonded together). The coextrusion process can be as many as 10 layers or more depending on the extrusion machine configuration and the requirements of the finished sheet. That is, additional layers for performance enhancement or incorporation of other additives, as described above, can be incorporated into the laminate structure during the coextrusion process for joining the first and second polyester layers. The additional layers can be disposed on either side or between the first second polyester layers depending on the desired properties of the structures and/or the types of additives incorporated therein. In an embodiment, the coextrusion of the first and second polyester layer and the lamination the coextrusion to the adhered third and fourth layer structure can occur in a single process. For example, the first and second layers can be coextruded and then the adhesively laminated third layer structure is brought into contact with the molten coextrusion and thermally bounded to the coextrusion.

In embodiments in which a sliver metal color is desired, the second polyester layer can be colored black. The non-metalized polyester layer can be laminated to the metalized polyester/protective layer laminate by an known methods, including, for example thermal lamination. For example, a sheet extrusion process can be used to thermally laminate these structures. Other lamination processes are possible such as solvent borne and solvent free as well as an extrusion lamination process.

In any of the foregoing laminate embodiments, the first laminate layer can have a thickness of about 6 mils to about 40 mils, about 5 mils to about 40 mils, about 10 mils to about 30 mils, and about 15 mils to about 35 mils. Other suitable thicknesses include about 6, 7, 8, 9, 10, 11, 12, 14, 15, 16, 17, 18, 19, 20, 22, 24, 26, 28, 30, 32, 34, 36, 38, and 40.

In any of the foregoing laminate embodiments, the second laminate layer and/or the third laminate layer can have a thickness of about 0.5 mils to about 5 mils, about 1 mil to about 5 mils, about 1 mil to about 2 mils, about 2 mils to about 4 mils, and about 2 mils to about 5 mils. Other suitable values includes about 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, and 5 mils.

Any of the roll stocks and laminates described herein can be thermoformed into various structures including cup-type structures. For example, cup structures having a draw depth of 1.5 inches can be achieved. Advantageously, thermoformed cups formed from the materials in accordance with the disclosure can be hot-filled with a product. Hot-filling is conventionally done at about 40° C. to about 85° C. At such temperatures, particularly at the higher end of the range, conventional thermoformed cups formed of polyester would distort upon heating, leading to defects in the cup structure and even leakage of the contents. Thermoformed cups in accordance with the disclosure can resist such temperature and maintain their structural integrity and aesthetic features during the hot-fill process.

### EXAMPLES

### Example 1

Thermoformable laminates were manufactured having the following multi-layered structure:

| | Percentage | | |
|---|---|---|---|
| | of Overall | Overall | |
| | thickness | Thickness | Material |
| Layer 1 | 70% | .016125″ | 77.93% PET - 17.4% Talc - 4.35% |
| | | | EMA -0.32% color concentrate |
| Layer 2 | 23.4% | .005375″ | 99% PET + 1% Carbon Black |
| Layer 3 | 3.3% | .00075″ | PET + vacuum deposition metal |
| Layer 4 | 3.3% | .00075″ | PET |
| Overall | 23 mil | .023″ | |

The colorant used in layer was Standridge Color Corp SCC#81446. The PET in each of the layers was thermoformable PET.

The laminate was made by adhesively laminating layer 3 to layer 4 using Henkel grade PB6305/PB600, a polyurethane solvent based adhesive. A aluminum coating was vacuum deposited onto a surface of layer 3. Layers 3 and 4 were adhesive joined such that the metallized coated surface of layer 3 was in contact with a surface of layer 4. Layer 4 was a substantially transparent PET roll stock. The resulting structure was thermally laminated to layers 1 and 2 in an extrusion process, such that layer 2 was in contact with the exposed surface of layer 3. Layer 1 was coextruded to layer 2 in the extrusion process.

### Examples 2-5

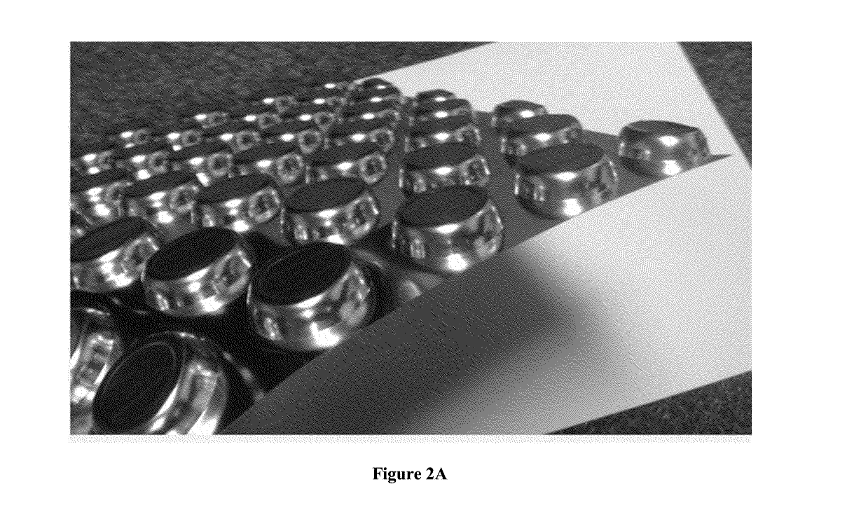

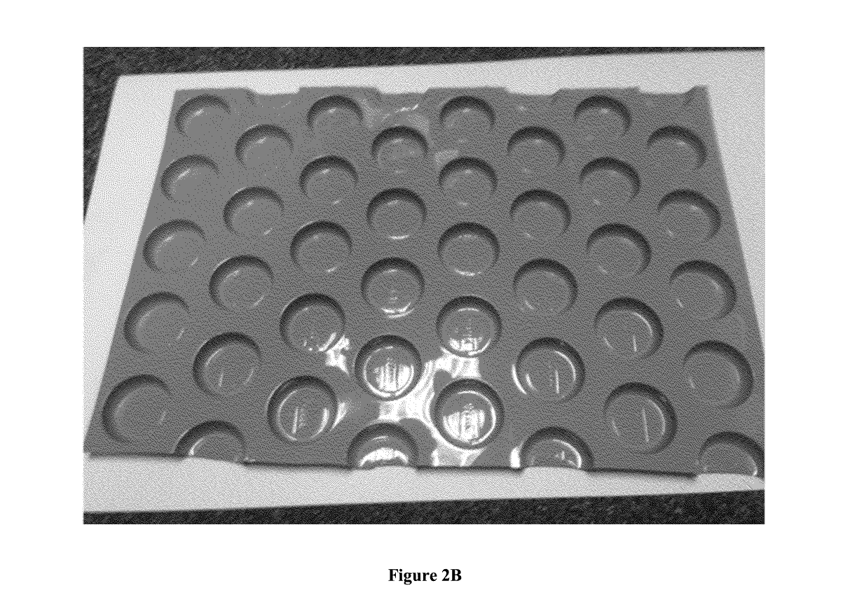

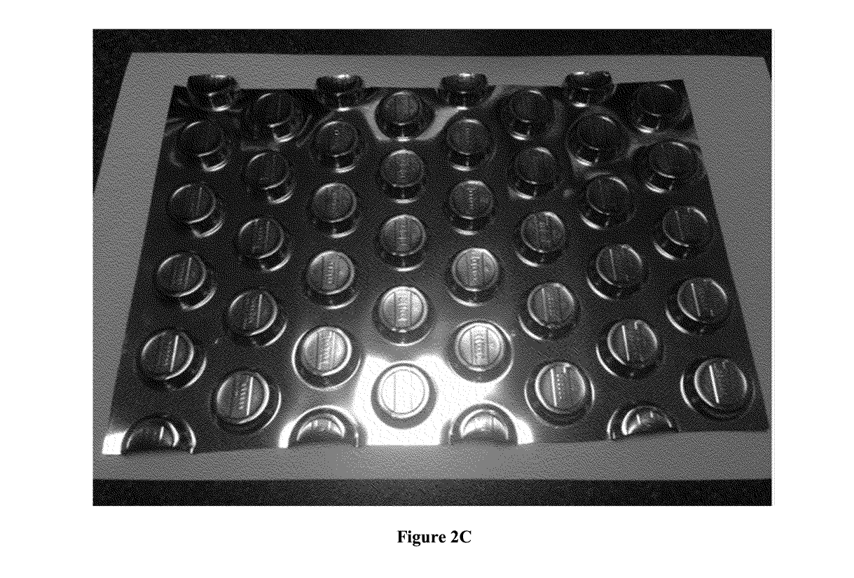

Referring to FIGS. 1A and 1B, cups were thermoformed from thermoformable laminates in accordance with embodiments of the disclosure. FIGS. 2A-2C illustrate other views of the formed cups. The containers were thermoformed such that a surface of the first layer of the laminate structure defined the inner surface of the cup and a surface of the fourth layer of the laminate structure defined an outer surface (bottom) of the cup. The laminate structures of the examples each had the following composition:

| | Percentage | | |
|---|---|---|---|
| | of Overall | Overall | |
| | thickness | Thickness | Material |
| Layer 1 | 63% | .00945″ | 77.93% PET - 17.4% Talc - 4.35% |
| | | | EMA - 0.32% color concentrate |
| Layer 2 | 27% | .00405″ | 99% PET + 1% Carbon Black |
| Layer 3 | 5% | .00075″ | PET + vacuum deposition metal |
| Layer 4 | 5% | .00075″ | PET |
| Overall | 15 mil | .015″ | |

The PET used in each of the layers was thermoformable PET. The color of the inside surface of the cups of the examples was varied by varying the color of the color concentrate in layer 1. In example 2, the color concentrate was white, in example 3, the color concentrate was grey, in example 4 the color concentrate was grey/black, and in example 5 the color concentrate was black.

The laminate structure was formed in each of the examples by adhesively laminating layer 3 to layer 4 using Henkel grade PB6305/PB600 coreactant, a polyurethane solvent based adhesive. An aluminum coating was vacuum deposited onto a surface of layer 3. Layers 3 and 4 were adhesive joined such that the metallized surface of layer 3 was in contact with a surface of layer 4. Layer 4 was a substantially transparent PET roll stock. The resulting structure was thermally laminated to layers 1 and 2 in an extrusion process, such that layer 2 was in contact with the exposed surface of layer 3. Layer 1 was coextruded to layer 2 in the extrusion process.

As shown in FIGS. 1A and 1B, the cups had a metal-like appearance. The metallization layer remained intact and attached to the laminate structure during the thermoforming process, providing a uniform metal appearance.

### Comparative Example

75 gauge (0.75 mil) PET roll stock was metalized using a vacuum deposition process. The PET roll stock was joined to a 25 mil black-colored PET sheet using a sheet extrusion process, resulting in thermal lamination of the PET roll stock to the PET sheet. The metallization layer of the PET roll stock was one of the exposed surfaces of the laminate structure. The laminate structure was thermoformed into cups. When the laminate structure was exposed to the thermoforming process, the metallization layer was abraded and stretched away from the laminate, with much of the metal coating being removed during the forming process.

While various embodiments have been described above, the disclosure is not intended to be limited thereto. Variations can be made to the disclosed embodiments that are still within the scope of the appended aspect.

1. A thermoformable, extruded polyester roll stock, comprising:
a polyester;
talc present in an amount of about 10 wt % to about 20 wt % based on the total weight of the roll stock; and
an ethylene acrylate, the ethylene acrylate being present in an amount up to about 6 wt % based on the total weight of the roll stock.

2. The roll stock of claim 1, further comprising a colorant.

3. (canceled)

4. (canceled)

5. (canceled)

6. The roll stock of claim 1, wherein the polyester is a polyethylene selected from the group consisting of recycled PET, post consumer recyclable PET, virgin PET, and combinations thereof.

7. (canceled)

8. (canceled)

9. The roll stock of claim 1, wherein the ethylene acrylate is selected from the group consisting of ethylene methyl acrylate (EMA), ethylene butyl acrylate (EBA), ethylene ethyl acrylate (EEA), copolymers, and combinations thereof.

10. (canceled)

11. (canceled)

12. The roll stock of claim 1, wherein the roll stock is free of defects selected from the group consisting of bumps (agglomerations), un-uniform shrinkage, fisheyes, dimples

13. A multi-layered co-extruded roll stock, comprising:
an A layer comprising polyester; and
a B layer comprising polyester, talc present in an amount of about 10 wt % to about 20 wt % based on the total weight of the B layer, and an ethylene acrylate present in an amount up to about 6 wt % based on the total weight of the polyester.

14. The roll stock of claim 13, wherein the roll stock has an AB structure.

15. The roll stock of claim 14, wherein the roll stock has a thickness ratio of A layer to B layer of about 5:95 to about 50:50.

16. (canceled)

17. The roll stock of claim 13, wherein the film has an ABA structure.

18. The roll stock of claim 17, wherein the film has a thickness ratio of A layer to B layer to A layer of about 5:90:5 to about 20:60:20.

19. (canceled)

20. The roll stock of claim 13, wherein one or both of the A layer and B layer comprises a colorant.

21. The roll stock of claim 13, further comprising a C layer comprising a polyester and a colorant and wherein the roll stock has an ABC structure.

22. (canceled)

23. (canceled)

24. The roll stock of claim 21, wherein the film has a thickness ratio of A layer to B layer to C layer of about 5:90:5 to about 20:60:20.

25. (canceled)

26. (canceled)

27. (canceled)

28. (canceled)

29. (canceled)

30. (canceled)

31. The roll stock of claim 13, wherein the ethylene acrylate is selected from the group consisting of ethylene methyl acrylate (EMA), ethylene butyl acrylate (EBA), ethylene ethyl acrylate (EEA), copolymers, and combinations thereof.

32. The roll stock of claim 13, wherein the ethylene acrylate comprises ethylene methyl acrylate.

33. (canceled)

34. The roll stock of claim 13, wherein the roll stock is free of defects selected from the group consisting of bumps, agglomerations, shrinkage, fisheyes, dimples.

35. A thermoformed cup formed from the roll stock of claim 1.

36. A hot-filled thermoformed cup comprising:
a thermoformed cup formed from the roll stock of claim 1,
a product filled in the thermoformed cup at a temperature of about 40° C. to about 85° C.

37. A thermoformed cup formed from the roll stock of claim 13.

38. A hot-filled thermoformed cup, comprising:
a thermoformed cup formed from the roll stock of claim 13; and
a product filled in the thermoformed cup at a temperature of about 40° C. to about 85° C.

39. The cup of claim 36, wherein the cup has a draw depth of about 1.5 inches.

40. A laminate comprising:
a first laminate layer comprising a polyester roll stock comprising a polyester, talc, and an ethylene acrylate, wherein the talc is present in an amount of about 10 wt % to about 20 wt % based on the total weight of the first laminate layer, and the ethylene acrylate is present in an amount up to about 6 wt % based on the total weight of the first laminate layer; and
a second laminate layer attached to the first laminate layer.

41. The laminate of claim 40, wherein the second laminate layer comprises polyethylene.

42. The laminate of claim 40, wherein the second laminate layer is a multi-layer co-extruded roll stock comprising a first polyethylene layer, a first tie layer adjacent to the first polyethylene layer, an EVOH layer adjacent to the first layer, a second tie layer adjacent to the EVOH layer, and a second polyethylene layer adjacent to the EVOH layer.

43. The laminate of claim 42, wherein the second laminate layer has a thickness of about 0.5 mils to about 5 mils.

44. The laminate of claim 40, wherein the second laminate layer comprises a polyester having one surface printed with an ink.

45. The laminate of claim 44, further comprising a third laminate layer attached to the second laminate layer with an adhesive, wherein the third laminate layer is attached to the surface of the polyester printed with the ink and the third laminate layer comprises a polyester.

46. The laminate of claim 45, wherein the third laminate layer comprises PET comprising a metallization layer.

47. (canceled)

48. (canceled)

49. The laminate of claim 46, wherein the metallization layer is formed from aluminum, silver, gold, copper, alloys thereof, and combinations thereof.

50. (canceled)

51. (canceled)

52. The laminate of claim 40, wherein the first laminate layer has a thickness of about 6 mils to about 40 mils.

53. The laminate of claim 40, wherein the first laminate layer comprises an extruded multilayer polyester roll stock comprising an A layer and a B layer and optionally a C layer, wherein:
the A layer comprises a polyester;
the B layer comprises the polyester, the talc, and the ethylene acrylate, and
the C layer comprises a polyester.

54. (canceled)

55. The laminate of claim 53, wherein the multilayer film has one of an AB structure, ABA structure, or an ABC structure.

56. (canceled)

57. A thermoformed cup formed from the roll stock of claim 40.

58. A hot-filled thermoformed cup comprising:
a thermoformed cup formed from the roll stock of claim 40; and
a product filled in the thermoformed cup at a temperature of about 40° C. to about 85° C.

59. A process of making a thermoformable polyester roll stock, comprising:
combining a polyester, talc, an ethylene acrylate, wherein the talc is present in an amount of about 10 wt % to about 20 wt % based on the total weight of the roll stock, and the ethylene acrylate is present in an amount up to about 6 wt % based on the total weight of the roll stock,
crystalizing and drying the combination of the polyester, talc, and ethylene acrylate at a temperature of at least about 145° C.; and
feeding the crystalized and dried combination into a screw of a single screw extruder and extruding the roll stock.

60. The process of claim 59, wherein the combining step comprises combining polyester with a masterbatch comprises a polyester, the talc, and the ethylene acrylate.

61. The process of claim 60, wherein the masterbatch further comprises a colorant.

62. The process of claim 60, wherein the combining step comprises combining about 1 wt % to about 20 wt % polyester with about 80 wt % to about 99 wt % masterbatch.

63. The process of claim 59, further comprising combining a colorant with the polyester, the talc, and the ethylene acrylate.
